(19) United States
(12) Patent Application Publication
(10) Pub. No.: US 2015/0206241 A1
(43) Pub. Date: Jul. 23, 2015

(54) FINANCIAL INSTRUMENT ONLINE COMMUNICATION SYSTEM

(71) Applicant: Dealvector, Inc., Sausalito, CA (US)

(72) Inventors: Michael Manning, Corte Madera, CA (US); David Jefferds, Boca Raton, CA (US)

(21) Appl. No.: 14/160,415

(22) Filed: Jan. 21, 2014

(51) Int. Cl. G06Q 40/06; H04L 29/06; G06F 21/62

(52) U.S. Cl. CPC G06Q 40/06; H04L 63/08; G06F 21/6245; G06Q 40/04

(57) ABSTRACT

A method and system for managing and facilitating communications among affiliants to financial instruments that otherwise are precluded from directly and optimally interacting via the Street Name System is provided. More particularly software-based tools are provided that allow immediate, identity-protected responses and dialogued messaging among parties that can be validated with respect to their affiliations when they interact. The platform also allows holder-to-holder communications, which is not currently possible within the Street Name System. It can facilitate interactions among all types of affiliants to a financial instrument whether issuer, holder, lawyer, service provider, or otherwise.

### BACKGROUND

The present application relates to computer implemented methods and systems that provide a platform to assist holders, issuers and other affiliants of financial instruments to overcome the communication limitations imposed by the current financial information infrastructure, aka the “Street Name System”. Many financial instruments are held in “street name,” in which the registered owner is a depository called DTCC in the United States, or ClearStream or Euroclear in Europe. The depositories hold the shares in these assets on behalf of brokers, banks, or other third party financial institutions, (the “Street Name” holders), who in turn custody the economic interest in the asset (the “Security Entitlement”) on behalf of their customers who are the true Beneficial Owners of the asset. This practice of registering financial instruments in the name of an institution who custodies the Security Interest rather than the underlying Beneficial Owners helps to facilitate the processing of transactions. Many years ago, instruments were traded only with paper certificates. For example, brokers on Wall Street hired runners to exchange stock certificates among financial institutions at the end of each trading day. As the trading of financial instruments became more sophisticated and in larger volumes, Wall Street suffered a paperwork crisis that almost crippled the securities industry in the late 1960's. Today, transactions are settled through the use of depositories. These depositories register and hold the instruments in “nominee” name for financial institutions, such as brokers and banks, which are participants in this system. By holding securities in nominee name, these depositories are able to facilitate transfers by computerized book-entry systems, instead of having to physically move stock certificates or formally transfer record ownership. Under the Street Name System, a depository is the actual shareholder of record, meaning that it is the official owner of the economic interest in the instrument, even though it is not the individual or institution that is the underlying owner. Under this system, the underlying owner is called the “beneficial owner.” The beneficial owner enjoys the benefits of the instrument, for example in the case of shares, the receipt of dividends and the right to vote on important corporate matters, but does not hold legal title to the shares. The vast majority of securities and other instruments are deposited with The Depository Trust Company (DTC), a clearing agency that is registered with the U.S. Securities and Exchange Commission (SEC).

Under the Street Name System beneficial owners of financial instruments can only receive any information or communications related to those financial instruments via the broker, bank, or other financial institution that holds their account. Similarly, no information about the beneficial owner can be found without first going through such financial institution. As a result of this arrangement, issuers do not typically know the identities of the beneficial owners of their financial liabilities. Nor are beneficial owners aware of, or able to find, the identities of other beneficial owners with whom they may want to communicate. Nor are other types of affiliants able to become aware of the identities of affiliants or to benefit from the Street Name System at all.

The messaging that is possible today via the Street Name System has several important limitations. It is slow and does not facilitate dialogue. Generally, only issuers and trustees are entitled to request that messages be sent to holders through the system. When such messages are sent they can move through several layers of parties at different institutions before reaching their intended recipient. The message may take several weeks to reach the recipient, even for time sensitive matters. If the recipient has any questions, comments or feedback in the nature of initiating a dialogue, he or she must find a way to reach out to the sender directly, outside of any Street Name System channel. Finally, many recipients of such messages may be interested in learning more information but are reluctant to disclose their identities, and there is no system facilitating this type of identity-protected response. Nor is there an efficient method for facilitating mutual disclosure of identities once both parties were to elect to do so.

These limitations impose a tremendous dead-weight loss on the entire economy by discouraging dialogue and fruitful interactions. This is particularly true for less liquid assets where control issues may exist.

Prior solutions to the above problems have attempted to use social networking to allow voluntary communication between various groups within the street name system, particularly issuers and holders. However these systems operate outside the street name system and thus lack the validations and safety provided by the street name system.

What is needed is a system and method that provides query addressing functionality such that message authors can differentiate categories of recipient based upon criteria such as title, type or validation status and which provides for the suppression of messages to particular recipients and groups of recipients and the selection of groups of recipients based upon author selected criteria all while preserving the beneficial safety of using the street name system for validation or using other superior content-driven validation tools.

### SUMMARY OF THE INVENTION

Broadly, the present invention provides a method and system for managing and facilitating communications among affiliants to financial instruments that otherwise are precluded from directly and optimally interacting via the Street Name System. More particularly, aspects of the present application remedy the shortcomings of the prior art by providing tools that allow immediate, identity-protected responses and dialogued messaging among parties that can be validated with respect to their affiliations when they interact. The platform also allows holder-to-holder communications, which is not currently possible within the Street Name System. Indeed it can facilitate interactions among all types of affiliants to a financial instrument whether issuer, holder, lawyer, service provider, or otherwise.

In one exemplary embodiment of the present invention, the system provides an environment where users can identify their affiliations to particular instruments and register such affiliations in a non-searchable registry. Such registry can be used to make users eligible to receive messages related to those instruments based on the affiliations provided.

In another exemplary embodiment, the system tools allow users to specify recipients of messaging according to the financial instrument as well as the recorded recipient affiliation type (i.e. investor, lawyer, etc) and to send instantaneous identity-protected messages to recipient groups meeting the specified criteria. Recipients can similarly reply in an identity-protected manner.

In another exemplary embodiment, the system tools allow users to be validated with respect to the professional role (firm, role) that characterizes the user asserting the affiliation to the financial instrument.

In another exemplary embodiment, the system tools allow users to require documentary evidence of affiliations from other parties prior to proceeding with communications.

In another exemplary embodiment, the system allows conversations among groups of affiliants to be narrowed to bilateral dialogues among just two affiliants.

In another exemplary embodiment, the system tools allow users to mutually opt-in to simultaneously reveal identities and contact information, thereby mitigating risk of one-sided identity disclosure.

In another exemplary embodiment, the system tools allow users to send broadcast messages in a non-identity protected manner to targeted affiliants and to receive responses that are identity-protected.

In another exemplary embodiment, the system tools allow users to rate the quality of interactions with other identity-protected users via a scoring method.

In another exemplary embodiment, the system tools allow users to invite new users into the system and to track the number of successful invitations as an additional metric of social proof for identity-protected users.

In another exemplary embodiment, the system tools allow users to compare visibility on the indicative pricing and/or marking of particular financial instruments as a method for determining if dialogue among identity-protected users is warranted.

In another exemplary embodiment, the system tools allow users to invite new users from a second network (such as the street name system) via the provision of a URL link that preserves the identity protection of the new user, yet that also preserves the validation benefits relating to the messaging protocols and restrictions of the second network, when the new user is brought onto the system.

### BRIEF DESCRIPTION OF THE DRAWINGS

The preferred embodiment of the invention will hereinafter be described in conjunction with the appended drawings provided to illustrate and not to limit the scope of the invention, wherein like designation denote like element and in which:

FIG. 1 depicts a flowchart of a method of transmitting data via an embodiment of the present invention.

FIGS. 2 and 3 show a schema of a database of an embodiment of the present invention.

FIG. 4 depicts a network structure of an embodiment of the present invention.

FIG. 5 depicts a user account view activity summary and add tool of an embodiment of the present invention.

FIG. 6 shows a Deal Center view with an add deal and archive deal tool of an embodiment of the present invention.

FIG. 7 shows a further detail of search and add tools of an embodiment of the present invention.

FIG. 8 depicts a message center and query tool of an embodiment of the present invention.

FIG. 9 shows a marks posting and display tool of an embodiment of the present invention.

FIG. 10 depicts a use case of an embodiment of the present invention.

FIG. 11 depicts an Investorlink broadcast message suitable for delivery via link to street name system network users.

FIG. 12 depicts a process flow diagram related to user interactions with DealVector and the street name system.

### DETAILED DESCRIPTION

In the following detailed description of embodiments of the invention, numerous specific details are set forth in order to provide a thorough understanding of the embodiment of invention. However, it will be obvious to a person skilled in art that the embodiments of invention may be practiced with or without these specific details. In other instances well known methods, procedures and components have not been described in detail so as to not unnecessarily obscure aspects of the embodiments of the invention. Furthermore, it will be clear that the invention is not limited to these embodiments only. Numerous modifications, changes, variations, substitutions and equivalents will be apparent to those skilled in the art, without parting from the spirit and scope of the invention.

Broadly, the present invention lies in a system and method of connecting a sub-set of members who are affiliated with one or more financial instruments whereby a member may communicate with selected members based upon defined criteria. More specifically, anonymity is maintained wherein users may compare and discuss relevant topics such as control issues, marks, or otherwise on specific assets with other holders, using identity-protected messaging for as long as desired, with such identity-protected messaging benefiting from the validation, verification and confidence-enhancement tools of the system. In embodiments of the present invention, users may define several vectors of communication that determine the characteristics of a targeted message recipient group; principally these vectors relate to the financial instrument that is the subject of the messaging, the types of affiliants to the financial instrument, and the validation status of those affilations. In embodiments of the present invention, an opt-in method is used to allow users to view each other's marks whereby a user must post a mark with respect to a deal in order to view other members' marks. In embodiments of the present invention, an opt-in method is used to allow users to compare mutual price visibility with respect to particular assets without actually seeing the prices of other users, and to initiate communications with respect to that pricing. In embodiments of the present invention, a method is used to allow users to broadcast non-identity-protected messages and invitations to non-users of the platform which, if accepted, allow the recipients to join the system and view the communications while maintaining their own identity protection. Generally the system and method can be divided into three areas: (1) member validation, (2) anonymous communications and (3) selective communications. We discuss each with respect to an exemplary embodiment of the present invention.

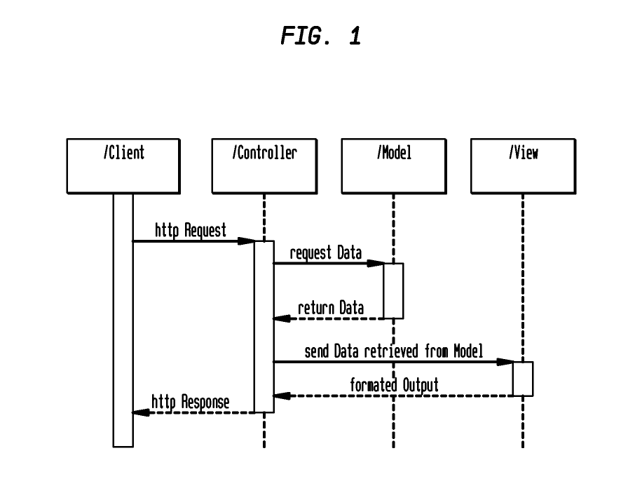

Referring now to FIG. 1, the system includes one or more client devices, a network, and one or more network servers. The network is in communication with and facilitates communication between the client devices and network servers. Client devices include any computing device capable of receiving and sending a message over a network. Such client devices typically connect to the network servers using either wired or wireless communications and include personal computers, netbooks, laptops, smartphones, tablet computers, cell phones or any other computing device including any mobile computing device.

Each client device is equipped with application software which can receive and send data to the network servers, display information to the user and allow for entry of data by the user. Preferably, such application software is a browser application that is configured to send and receive webpages, private messages, postings, emails and the like and may utilize HTML or applet or a combination of both to achieve the foregoing, examples of which include Internet Explorer, Firefox, Chrome, and Opera. And preferably, such browser application is configured to display graphics, text, multimedia and the like and employs any web based language, such as hypertext markup language HTML, Java-Script, Flash and the like. The browser application may be written and programmed to run on the .net framework or may utilize any other suitable framework and programming language(s).

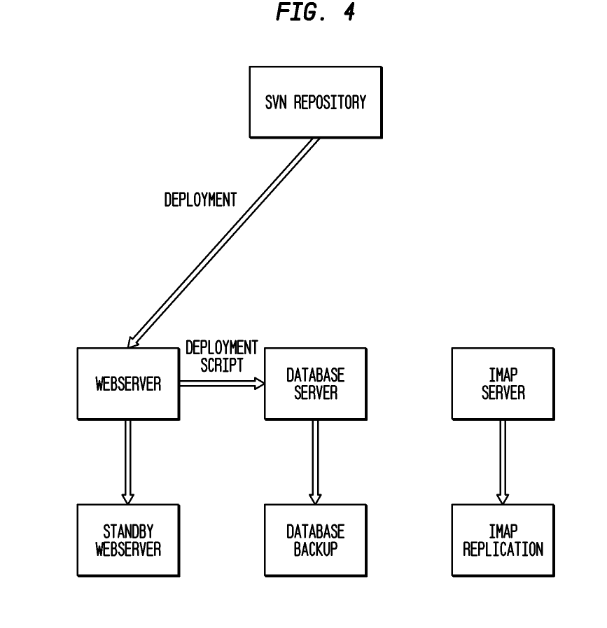

In an embodiment of the present invention, three packages: the client layer, business layer (web server) and data layer are included in the system of the present invention. As shown in FIG. 4, the data layer includes two components—a database and IMAP server storage. Preferably the user interface, business logic and data are segregated into distinct software components.

Referring now to the client layer, a user may create an account which is stored in the database. The user may then affiliate themselves with one or more “deals”. Such deals typically reflect a particular financial instrument. A user may search the system for deals which are stored in the database. Once a deal is located with respect to which the user believes it has an affiliation, the user may request that the system add that deal to their account. In order to preclude users from providing false information, the system employs a multi-pronged set of validation and verification tools. Once affiliated with a deal, the user may communicate with other users and may restrict that communication according to deal affiliation and validation status. If a user opts to post their communication, mark, price visibility information, or other information on a deal, the system allows other users to see such communications when they meet the criteria relating to such communication. While, as discussed above, in the case of general messages these criteria relate principally to deal affiliation type and validation status, other types of communications have additional criteria. In particular, viewership of marks and bid/offer information requires the input by the recipient of similar types of matching information. Recipients of broadcast messages sent to other networks (such as the street name system) must meet the categorical requirements as specified with respect to those networks.

The verification and validation tools allow users to prove affiliation to a deal. One method of proving affiliation is by uploading to the system a copy of deal documents. Such documents may be manually reviewed or may be reviewed via comparison to a database of keywords selected from and relevant to one or more deals known within the database. Another method of validation is via use of the street name system, in which an issuer sends a message to the holder with a validation link inviting them to join the deal and, if not already a user, setup an account on the system. Validation uniform resource locator (URL) links are generated by the system using a combination of the domain name, subdomains specific to issuers of financial instruments, numerical identifiers of financial instruments, and randomized data or by any means usually employed to create validation URL links known to those of skill in the art. Yet other methods of validation are possible, such as the generation of an automated email verification message to the applicant's email address at the company for which they claim to work, which includes a link to complete the verification process. Such user-provided email addresses can be matched to known email domains for financial firms in order to weed out fraudulent applicants. In further embodiments automated or manual verification by telephone to the applicant's workplace is possible, with the recipient indicating by input to the telephone whether they actually applied for an account on the system. Different verification and validation methods may be used alone or in combination; users therefore may evaluate the verification and validation methods undertaken by other users to calibrate their interactions with such users.

The system allows users to be validated with respect to the professional role (issuer, beneficial holder, manager, legal, or other role) that characterizes the user asserting the affiliation to the financial instrument. For example, an issuer can communicate to holders via the street name system and include in such communication a secured link to join the system and validate the holder onto the issuer's deal. From then on, all communications between the issuer and other members of the deal on the system are handled by the system without use of the street name system communication layers.

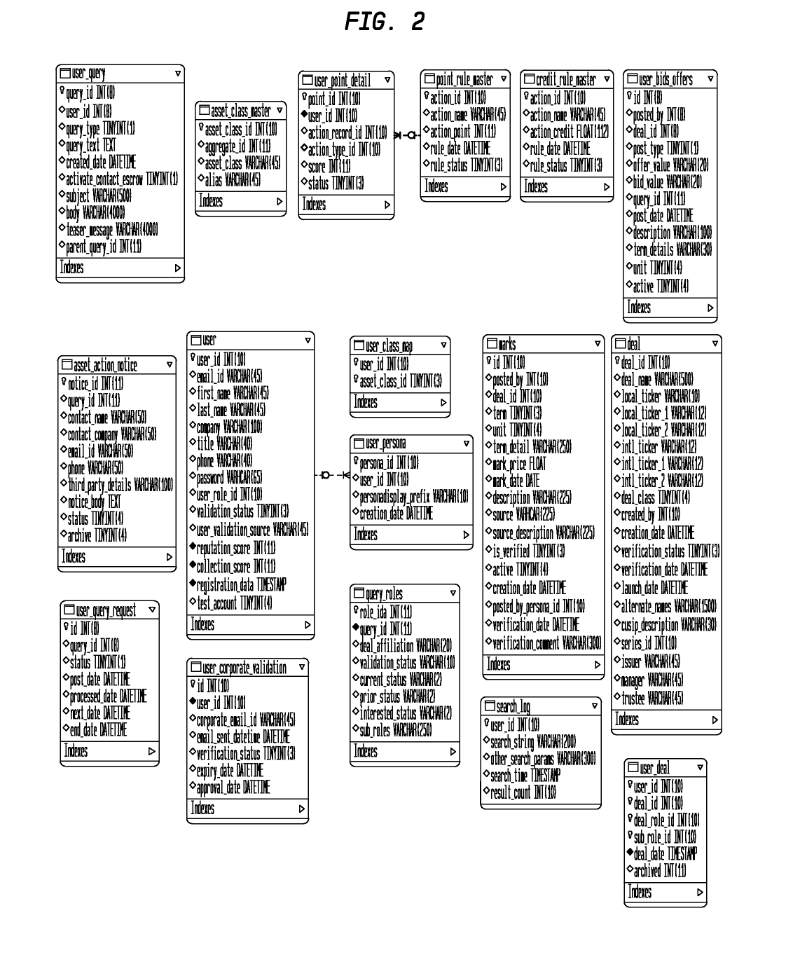

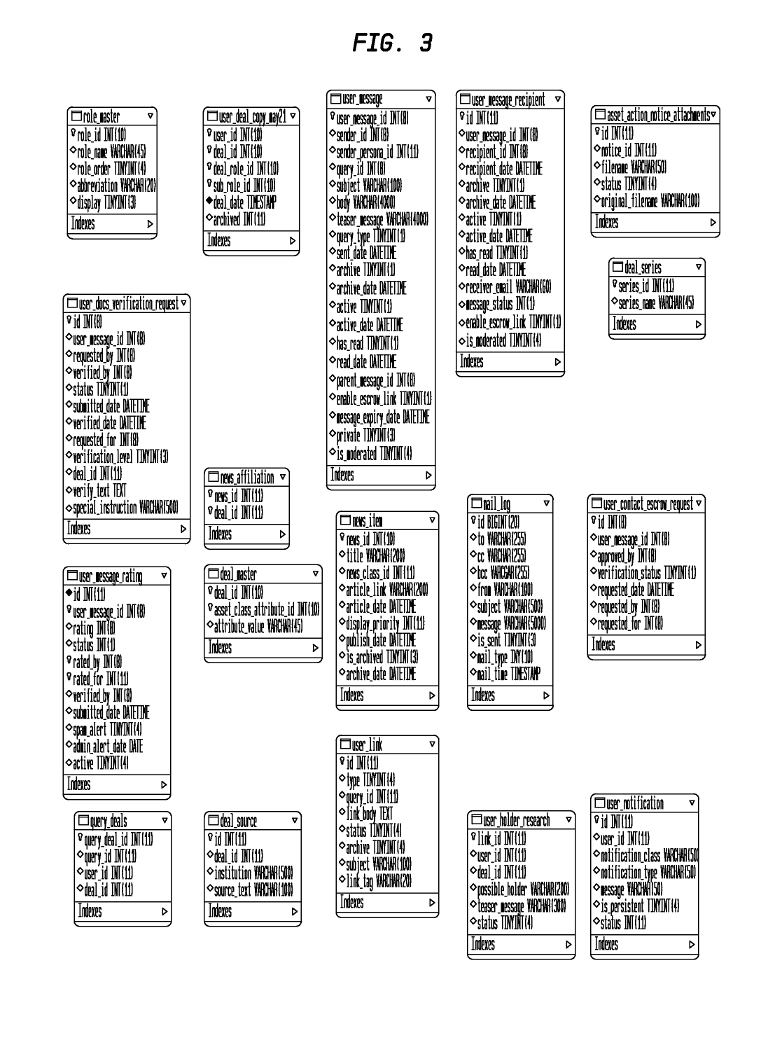

Referring now to FIGS. 2-3, user accounts contain data such as user identification number, email id (email address), first name, last name, company, title, phone number, password, user role, validation status, validation source, reputation score, connection score, and registration date, all of which is stored in the database, an example of which is shown in FIG. 2.

Users may also add deals to the system using an add deal function which allows the user to place a deal into the system. Such deals which are new to the system undergo a verification check. First the system engages in de-duplicating whereby deals with similar names or identification numbers, or both (such as the ubiquitous CUSIP identification number issued by the Committee on Uniform Security Identification Procedures) are automatically compared and if they match within a preselected range of similarity placed into a verification queue for manual verification versus matching similar deals. This avoids the creation of duplicate deals and serves to aggregate all users on a particular deal into one group. Second, the existence of a deal affiliation may be verified by the upload of documents concerning the deal, such as copies of account statements, trade tickets or other documents evidencing ownership. Users can gauge and interpret verification and validation status information in order to decide how to proceed further with identity-protected conversations and/or whether to seek mutual identity disclosure.

Users also receive reputational scores which may be made visible to other users of the system depending upon preselected criteria such as membership in one or more of the same deals. Reputational scores are based upon input from other users regarding communications received from the rated user. Such communications may be postings visible to single users or multiple users. In this way, disruptive users or those whose communications have little or no value to other users can be flagged by other users. The system may report reputational scores below a predetermined threshold to administrators for follow-up with the user or removal or suspension of the user's account. Alternatively the system may be automated and automatically suspend or terminate a user account with a reputational score below a predetermined threshold value.

Sophisticated query addressing is enabled by the system. Using user data it is possible to segregate recipients of a message initiated by a user by any combination of deal(s), recipient's role, reputational score, method of validation or any other criteria collected in the user's account profile. For example, in this way a holder may communicate only with other holders, or an issuer may communicate only with lawyers having worked on the deal. Because the user sending the message can preselect any criteria they can segregate the recipients to those holders who have validated via the street name system link for example, enabling a sender to further slice the recipient group into subcategories of their choosing.

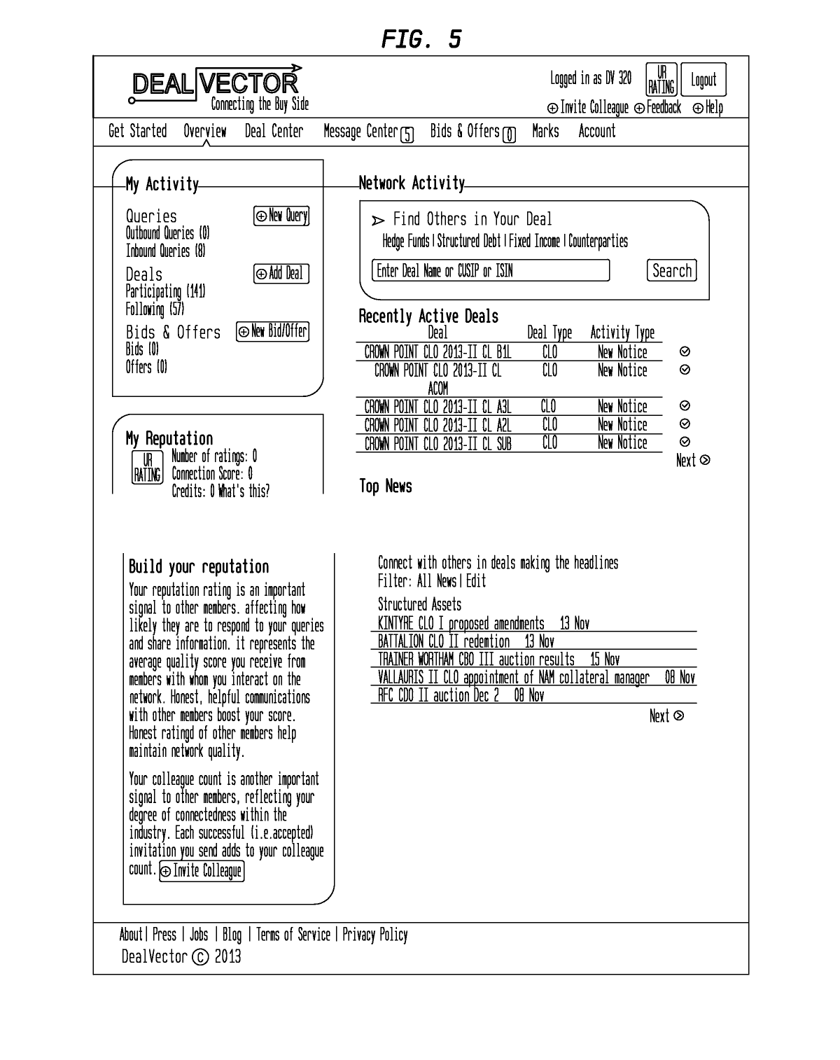

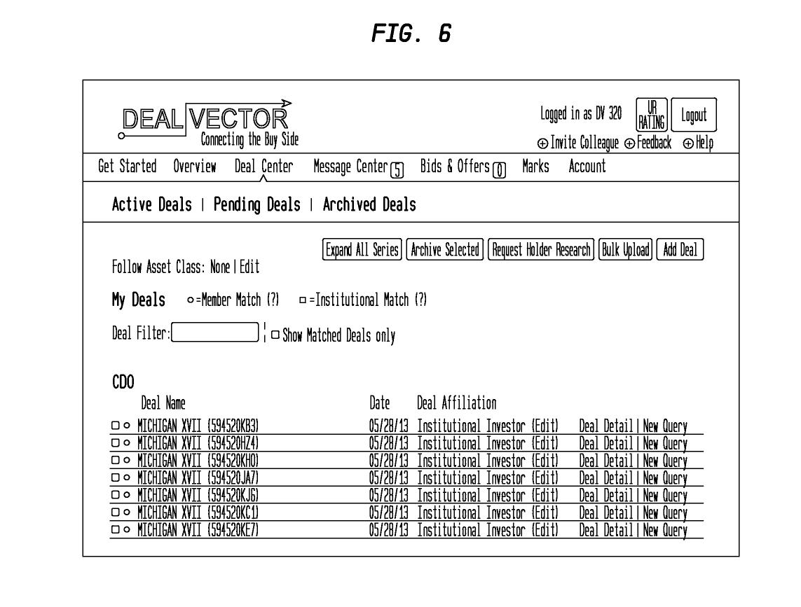

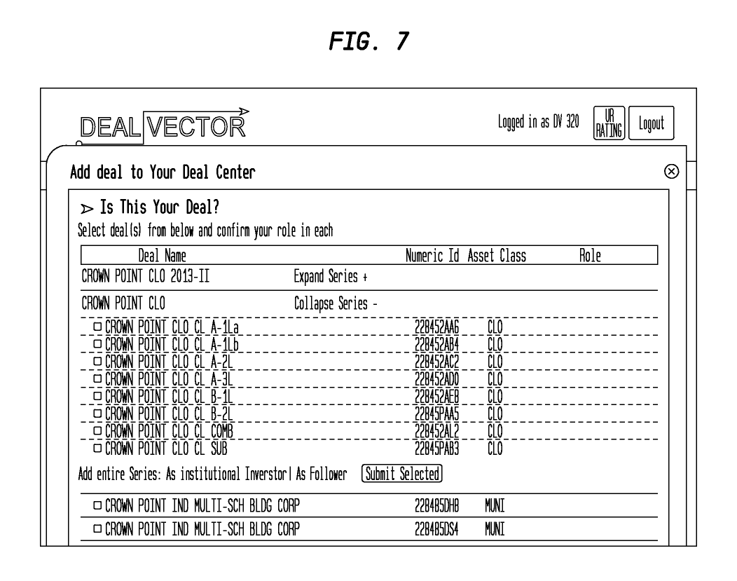

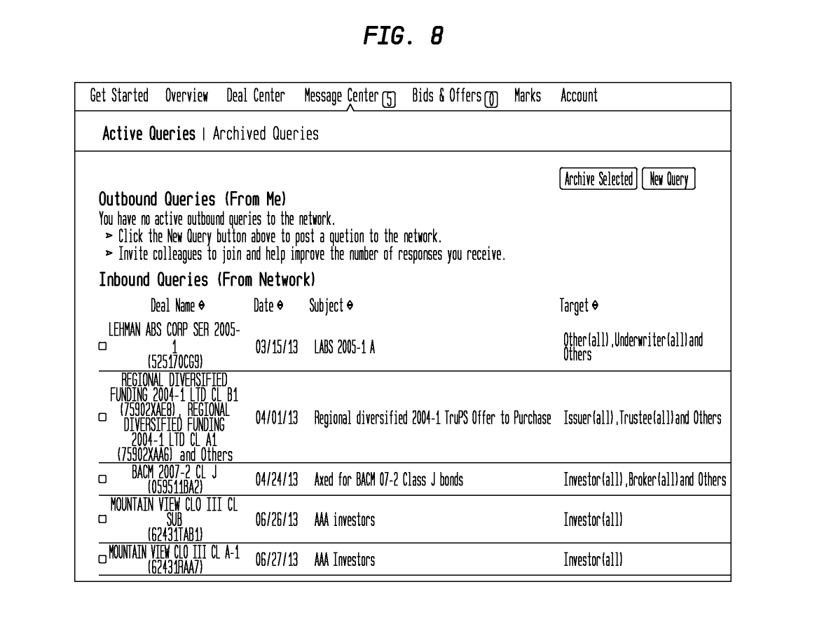

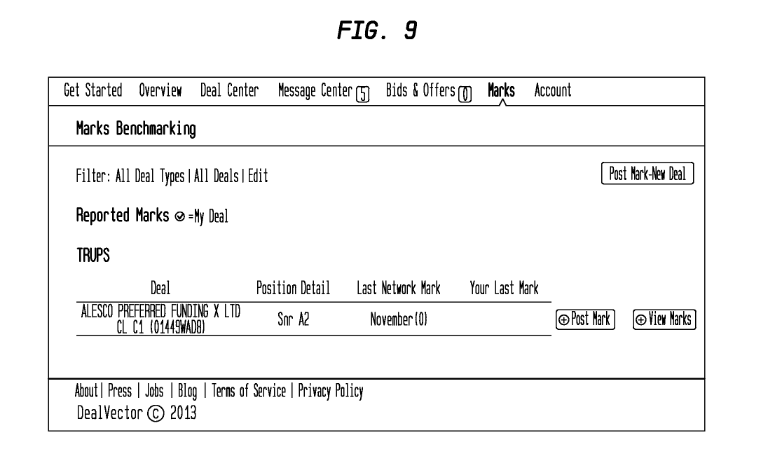

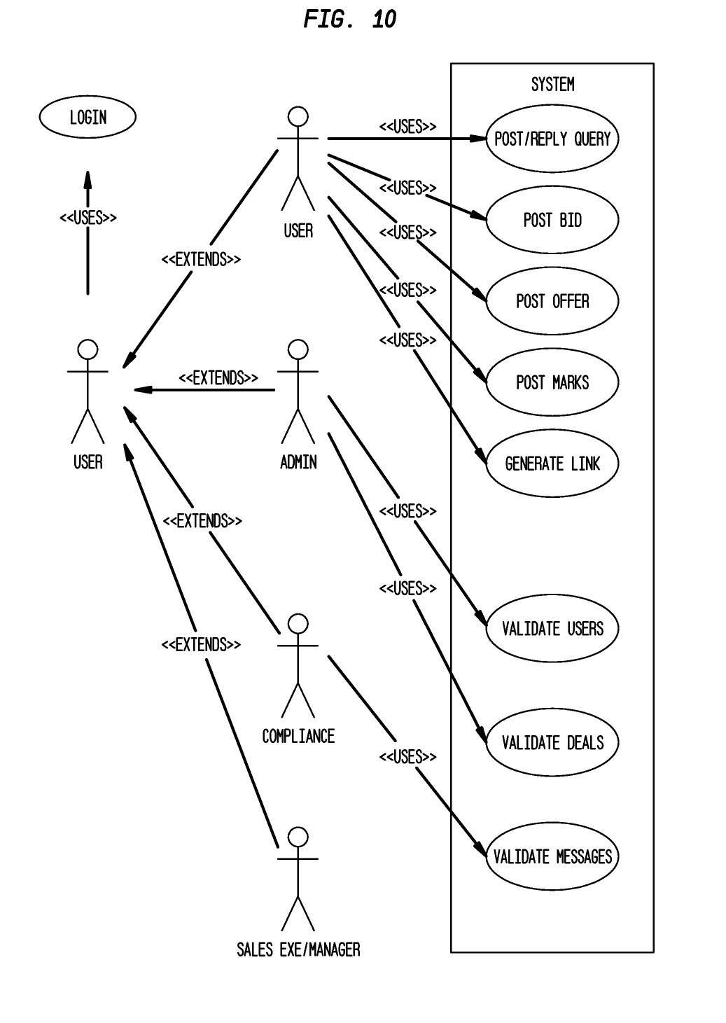

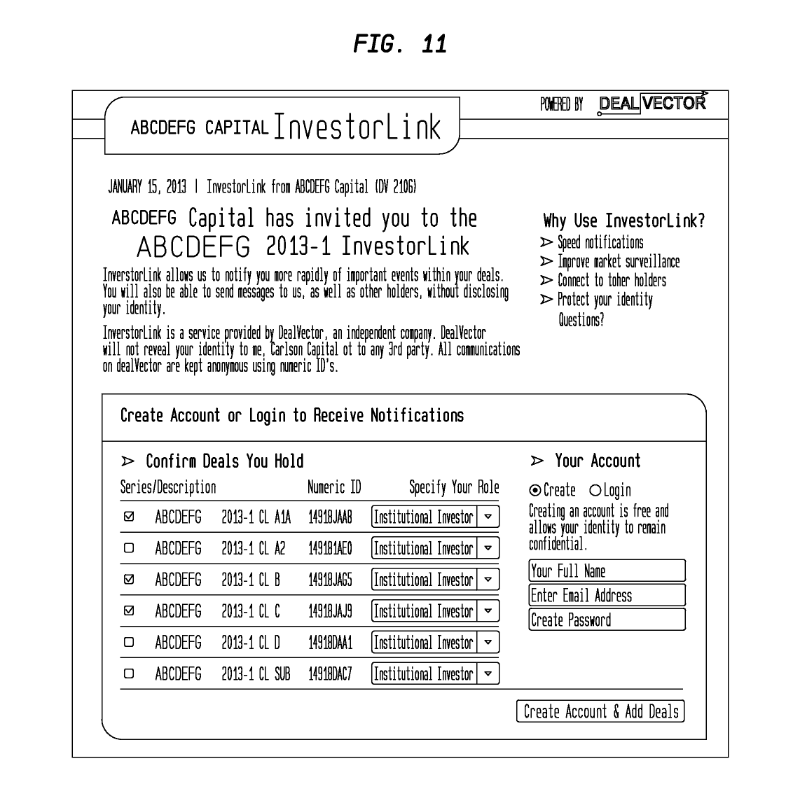

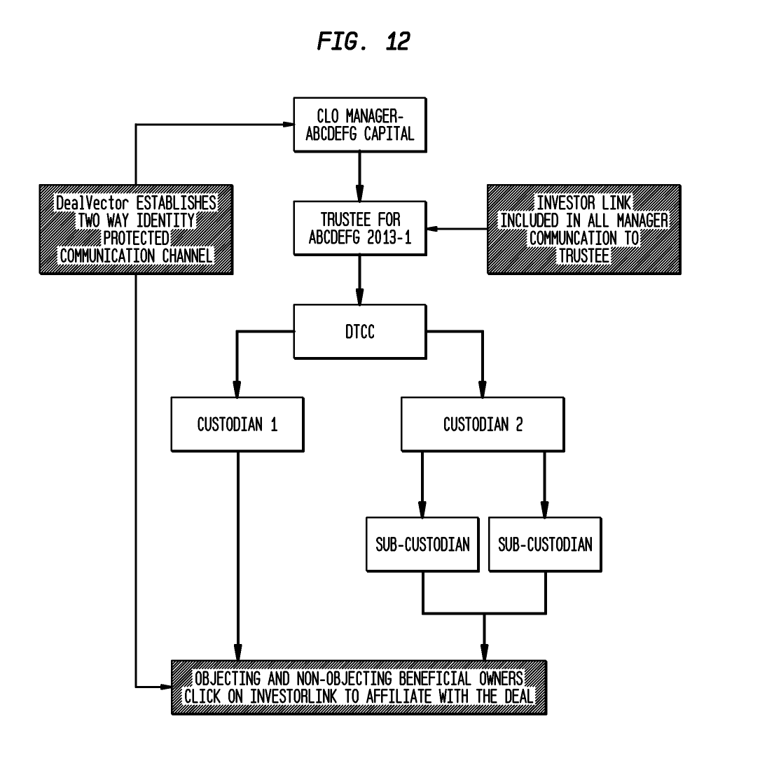

An exemplary embodiment of system and method is now described with reference to FIGS. 5-12. Users may log into the system and are divided into Normal Users, Administrative Users, Compliance Users, and Sales Users. The following four paragraphs provide descriptions with respect to Normal Users.

Such users may register onto the system to allow login. Registered users may add one or more deal(s) into their account. A user can also archive their deals, for example to store inactive deals or deals which the user has exited. Users may post queries. The post query messaging feature allows users to communicate with other affiliants of their deals by determining two vectors of communication: Deal and Deal Role. Messages are mediated using numeric identifiers, which serve to protect user identity until disclosure is elected on a mutual opt-in basis. Simultaneously, user authentication protocols including Role Validation, Reputation Score, and Document Verification provide confidence that each user is dealing with legitimate participants. A Contact Escrow protocol allows for simultaneous disclosure upon mutual opt-in to disclose identities.

A post bid and offer feature allows users to post information related to pricing visibility for a deal. The system matches user inputs and allows matching users to communicate anonymously following such matches. Bids and offers serves as a price discovery service that provides visibility into market demand, and lets investors share information while minimizing slippage into the market because the bids and offers are not displayed to all users. In exemplary embodiments, bids and offers can match when they are within a preselected range of one another or when they are of benefit to both parties versus other pricing known to the users. For example, buyers input 1) the lowest offer they have seen, and 2) the highest bid they would make. Sellers input the inverse price points. Matches require both parties to benefit the other. Price inputs are not revealed. Each user is told that a mutually beneficial match exists. Matched buyers and sellers can then communicate through a messaging feature and arrange to consummate a transaction if desired.

The post/view marks feature allows users to compare and discuss marks on specific assets with other holders, using identity-protected messaging for as long as desired. A user must post a mark with respect to a deal in order to view other members' marks. By enabling anonymous comparison of other user marks on a particular deal, a user can check the confidence of their mark for example, for illiquid assets held on the user's books.

Link distribution functionality allows a user to publish a notice and query related to one or more deal(s) and distribute a validation link to others via the street name system such that the sender's identity is disclosed but the recipient identities remain undisclosed. The link distribution tool allows holders of assets that are within the “street name system” financial architecture to communicate with an immediacy of response that facilitates real-time, identity-protected dialogue as recipients can respond back to the sender using the system instead of the street name system's cumbersome response methods (if even allowed).

Compliance users are accounts that are configured to allow compliance officers at financial firms to follow their firm's users on the system, rather than following deals as normal users would. Admin users are DealVector company staff users that have access to administrative tools. Sales users are DealVector company staff that have access to certain sales tools.

The embodiments of the present invention may be implemented using any appropriate computer system hardware and/or computer system software and network connections such as the Internet or wireless or wired networks. In this regard, those of ordinary skill in the art are well versed in the type of computer hardware that may be used (e.g. personal computers, networks, servers, and client devices), the type of programming techniques that may be used (e.g. object oriented programming), the types of computer languages that may be used for both the front end (e.g. the browser application or user interface) and back end of the system (e.g. the network server) (for example, PHP, Flash, C, C++, Java, Javascript, Python, FBML, Ajax, Erlang, D, Xhp may be used) and the type of database architecture and system to utilize (e.g. MySQL, Oracle, Microsoft SQL). In a preferred embodiment, LAMP stack, a combination of the Linux operating system, Apache HTTP Server web server, MySQL, MariaDB or MongoDB database management system, and PHP, Perl, or Python, the scripting languages (respectively programming languages) for dynamic web pages may be used.

It is understood that the embodiments described herein are illustrative only, and not restrictive, and that many modifications may become apparent to one of ordinary skill in the art without departing from the spirit and scope of the present invention.

1. A method of validating a first user of a first network onto a second network comprising the steps of:
(a) creating a validation URL link on a second network,
(b) sending of the validation URL link by a second user of the first network across the first network to the first user of the first network,
(c) authenticating the first user onto the second network when the user activates the validation URL link and selects at least one asset presented to the first user,
wherein the first network has parameters governing message delivery,
wherein the validation URL link links to a selectable affiliation to one or more assets, and
wherein the second network allows for immediate, bi-lateral communications in which the identity of the first user is undisclosed and validated with respect to the first network's parameters governing message delivery.

2. The method of claim 1 wherein the validation URL link allows more than one user to authenticate onto the first network and wherein further communications may be bi-lateral or multi-lateral to one or more authenticated users as selected by a sender.

3. A method of validating a user onto a network comprising the steps of:
(a) receiving an upload of a document from the user,
(b) detecting preselected keywords within the document by comparing words within the document with a database of keywords for a match,
(c) authenticating the first user to one or more groups,
wherein the one or more groups are related to the keyword.

4. The method of claim 3 wherein the keyword is a committee on uniform security identification procedures number (CUSIP), international securities identification number (ISIN) or other numeric identifier.

5. The method of claim 3 wherein the keyword is a numeric identifier, deal name or title of the financial instrument, issuer name, manager name, trustee name, and asset type.

6. The method of claim 5 wherein more than one category of keyword must be detected.

7. A method of communicating with one or more users on a network comprising the steps of:
(a) selecting one or more targeted recipient users based upon criteria selected from the group consisting of reference asset, user reference asset role, user reference asset affiliation validation status and
(b) transmitting a message to the set of selected users.

8. A system comprising:
(a) a user interface active on at least two client devices,
(b) a networked server in communication with the at least two client devices, and
(c) a database in communication with the networked server
wherein the database stores one or more user accounts which are authenticated onto the networked server by (a) creating a validation URL link, (b) sending the validation URL link to a user using the other network (c) authenticating the user onto the networked server when the user activates the validation URL link; wherein the other network allows one-way messaging from the user of the other network the user and wherein the user receives messages from the other network.

9. A method of valuing illiquid assets comprising:
(a) communicating at least two identifications for the illiquid asset, user identifications for the illiquid asset and sets of bid and offer valuations for the illiquid asset to a server,
(b) storing the identifications for the illiquid asset, the user identifications for the illiquid asset, and the sets of bid and offer valuations for the illiquid asset in a database in communication with the server,
(c) querying the database for sets of bid and offer valuations and user identifications for the illiquid asset and selecting those where a comparison of bid and offer valuation sets results in a narrower gap between bid and offer valuations,
(d) placing the two or more users into communication with each other without disclosing a user's bid and offer valuations to another user.

10. A method of disclosing user information on a mutual opt-in basis comprising:
(a) a first user activating a link that places the user account into a contingent disclosure status with respect to personally identifying information,
(b) a first user including such link in messaging to a second user,
(c) simultaneous release of personally identifying information to each user upon the second user activating the link provided by the first user.
